(19) United States
(12) Patent Application Publication
(10) Pub. No.: US 2006/0086792 A1
(43) Pub. Date: Apr. 27, 2006

(54) Flash card reader

(76) Inventors: Chia Li Chen, Hsin Tien City (TW); Hsiang An Hsieh, Hsin Tien City (TW); Sheng Pin Wu, Hsin Tien City (TW)

Correspondence Address: PRO-TECTOR INTERNATIONAL SERVICES, 20775 NORADA CT., SARATOGA, CA, 95070, US

(21) Appl. No.: 11/187,647

(22) Filed: Jul. 21, 2005

(30) Foreign Application Priority Data
Oct. 26, 2004 (TW) 093217018

(51) Int. Cl. G06K 7/06

(52) U.S. Cl. 235/441

(57) ABSTRACT

Provided is a flash card reader comprising two slot openings at both sides, a circuit board, and two sliding members each including an extended latch section adapted to lockingly engage a corresponding portion of a flash card inserted through the slot opening. Electrical terminals of the circuit board are electrically connected to electrical terminals of the inserted flash card. For ejecting the flash card, simply push a tab of the sliding member toward one side of the card reader for disengaging a corresponding portion of the flash card from the slot opening. The invention can effect the ejection by applying a minimum force. Thus, both the flash card and the card reader are more durable. Moreover, the inserted flash card is flexibly locked for preventing from accidentally throwing out from the card reader while carrying.

### BACKGROUND OF THE INVENTION

1. Field of Invention

The present invention relates to flash card readers and more particularly to such a flash card reader with improved card ejection mechanism and other improved characteristics.

2. Related Art

Flash cards are available in many types such as MMC (Multi Media card), SM (Smart Media card), SD (Secure Digital card), MS (Memory Stick card), MS Duo, Mini-SD, RS-MMC, and T-Flash. For reading data from a flash card, a flash card reader (called card reader hereinafter) is required.

A prior card reader is shown in FIG. 1. The card reader comprises a connector 10 within an opening. A card reader is provided in the connector 10 and comprises a rod 11. A user may operate a lever 13 at one side of the connector 10 to activate the rod 11. An end 111 of the rod 11 thus impinges a flash card 12 to throw it out from the opening. However, such impingement may damage the flash card 12 due to its strong force. Moreover, the connector 10 is relatively large and thus occupies excessive space on a circuit board 14. This can compromise the desired compactness of a card reader. Thus, a need for improvement exists.

### SUMMARY OF THE INVENTION

It is therefore an object of the present invention to provide a flash card reader having an improved card ejection mechanism for effecting the ejection of an inserted flash card by applying a minimum force to the flash card and the components of the card reader. Thus, both the flash card and the card reader are durable. Moreover, the inserted flash card is flexibly locked. Thus, a person does not need to worry that an inserted flash card may accidentally remove from a card reader while carrying. In addition, the internal space of the card reader is greatly decreased. Thus, the card reader can be more compact.

In one aspect of the present invention there is provided a flash card reader comprising a housing having an internal space for receiving two flash cards; and a circuit board disposed in the housing and including a plurality of electrical terminals at top and bottom surfaces thereof respectively, the electrical terminals of either surface being adapted to electrically connect electrical terminals of the inserted flash card, wherein the housing comprises two slot openings each disposed at either side, and a space inside each slot opening, the space being slightly larger than a portion of the flash card inserted into the slot opening.

In another aspect of the present invention, there is further provided a flash card reader comprising a housing including two slot openings each disposed at either side, and a space inside each slot opening, the space being slightly larger than a portion of a flash card inserted into the slot opening; a circuit board disposed in the housing and including a plurality of electrical terminals at one end, the electrical terminals being adapted to electrically connect electrical terminals of the inserted flash card; and two sliding members disposed in the housing and each including an extended latch section, wherein the latch section of the sliding member is adapted to lockingly engage a corresponding portion of the flash card inserted through the slot opening, the electrical terminals of the circuit board are adapted to electrically connect electrical terminals of the inserted flash card, and the latch section of the sliding member is adapted to disengage the corresponding portion of the inserted flash card for ejecting the flash card from the slot opening by operating the sliding member.

The above and other objects, features and advantages of the present invention will become apparent from the following detailed description taken with the accompanying drawings.

### BRIEF DESCRIPTION OF THE DRAWINGS

FIG. 1 is a top view of a slot opening of a conventional card reader with a flash card inserted thereinto;

FIG. 2 is an exploded view of a first preferred embodiment of card reader according to the invention;

FIG. 3 is a perspective view of the assembled card reader with two flash cards to be inserted thereinto;

FIG. 4 is a view similar to FIG. 3 where the flash cards have inserted into the card reader;

FIG. 5 is a sectional view taken along line A-A′ of FIG. 4;

FIG. 6 is a perspective view of a second preferred embodiment of card reader according to the invention;

FIG. 7 is a perspective view of the card reader of FIG. 6 with a cover removed for showing components thereof and inserted flash cards;

FIG. 8 is a perspective view of a sliding member of FIG. 6 viewed from its top and a coupled flash card;

FIG. 9 is a perspective view of the sliding member viewed from its bottom and the coupled flash card;

FIG. 10 is a top view of FIG. 6 with its cover being partially broken away for showing the locked position of an inserted flash card;

FIG. 11 is a view similar to FIG. 10 where the flash card has been ejected by pushing a push button of the sliding member;

FIG. 12 is a schematic top view of a third preferred embodiment of card reader according to the invention where one flash card is inserted and another flash card is ejected by operating one sliding member; and

FIG. 13 is a perspective view of a fourth preferred embodiment of card reader according to the invention where its cover is removed for showing components thereof and inserted flash cards.

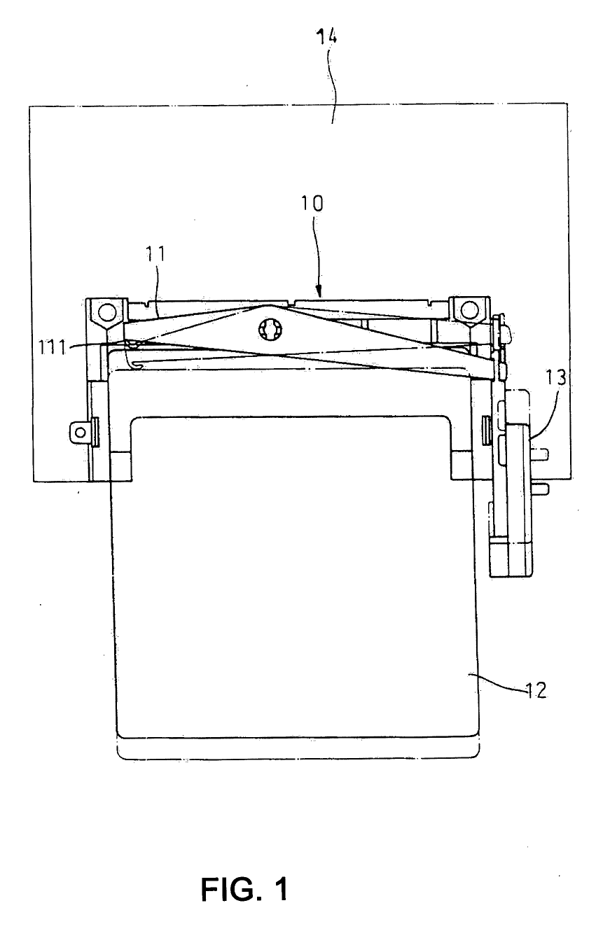

### DETAILED DESCRIPTION OF THE INVENTION

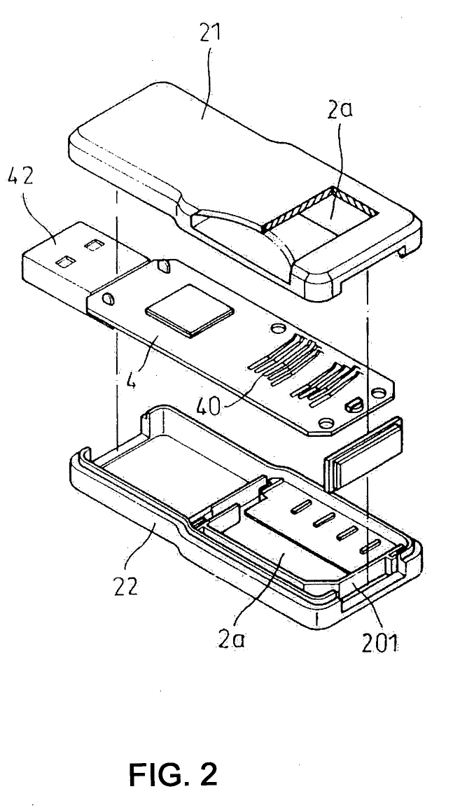

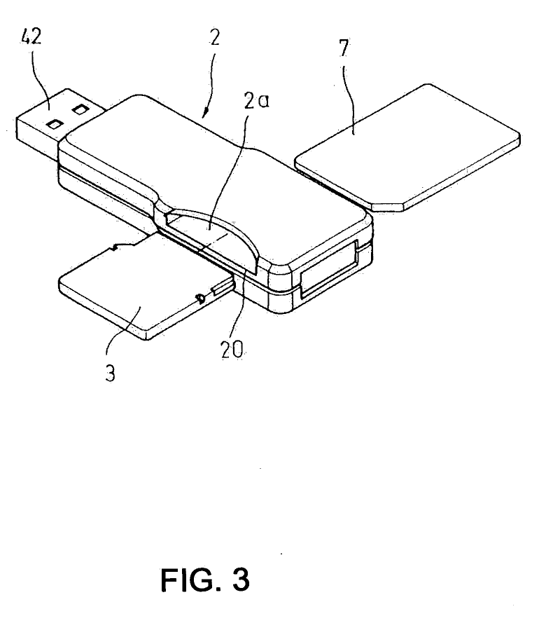

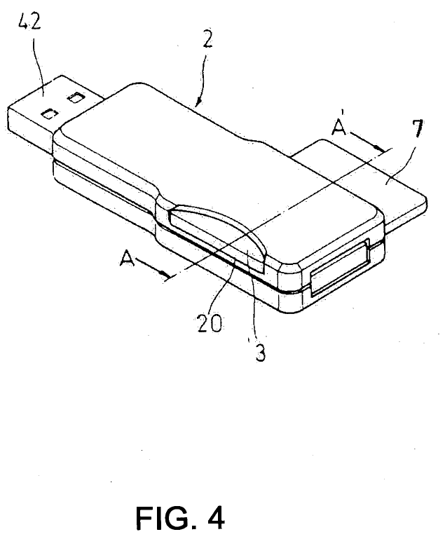

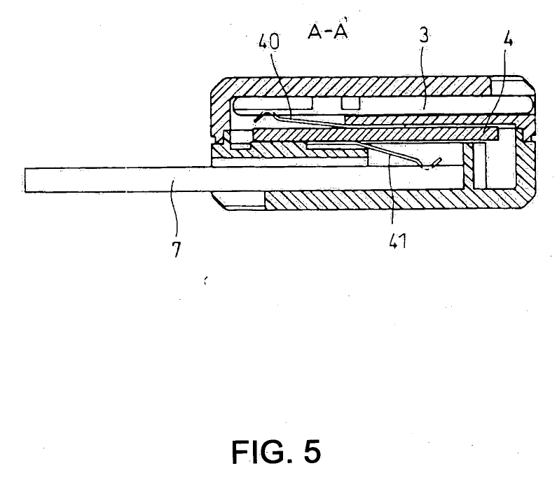

Referring to FIGS. 2 to 5, a substantially parallelepiped card reader in accordance with a first preferred embodiment of the invention comprises a housing 2 including a slot opening 20 at either side, a cover 21, and a base 22 having a wall 201; a circuit board 4 including a plurality of electrical terminals 40 and 41 at top and bottom surfaces thereof respectively, and a connector 42 projected from one end; and a space 2a inside either slot opening 20. The space 2a is defined by the wall 201 and is slightly larger than an inserted portion of a flash card 3 or 7. The connector 42 is implemented as a USB (universal serial bus) connector. The inserted flash card 3 is electrically connected to the terminals 40 and the inserted flash card 7 is electrically connected to the terminals 41. For reading data from an inserted flash card, a user may insert the connector 42 into a USB port of, for example, a personal computer.

Advantageously, internal space of the card reader is fully utilized. Moreover, no adapter is required for data reading. Both can contribute significantly to the minimization the size of the card reader.

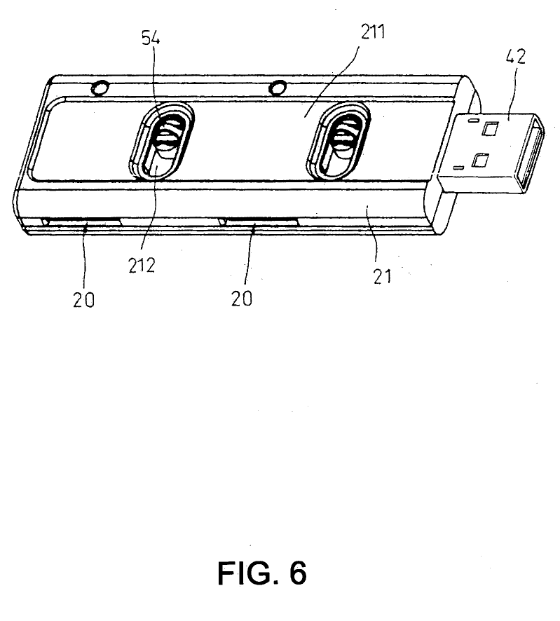

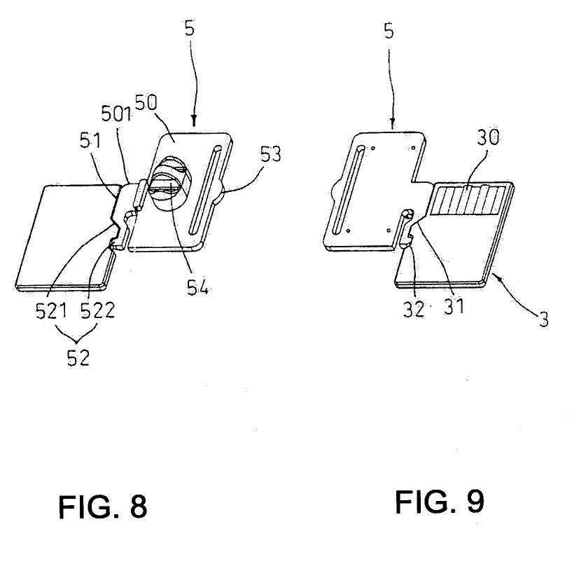

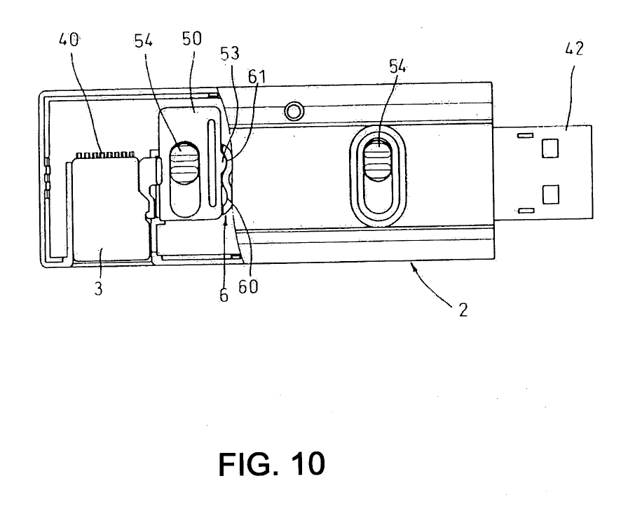

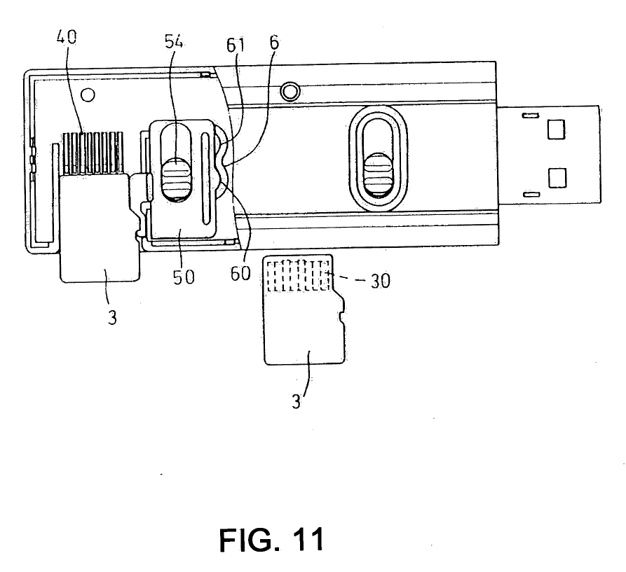

Referring to FIGS. 6 to 11, a card reader in accordance with a second preferred embodiment of the invention is shown. The characteristic of the second preferred embodiment is the provision of a card ejection mechanism as detailed below. Two pairs of sliding members 5 and lock members 6 are provided. Two spaced oval openings 212 are formed on a rectangular indentation 211 on the cover 21. The rectangular sliding member 5 comprises a top push button 54 projected from the opening 212, a tab 53 at one side, an extension 501 at the other side, an arm 51 oriented toward a slot opening 20, and a latch 52 including a slope 521 to be correspondingly engaged an inclined portion 31 at one side of the inserted flash card 3 (e.g., a T-Flash as shown), and an end protrusion 522 to be matingly engaged a dent 32 of the flash card 3 proximate the inclined portion 31.

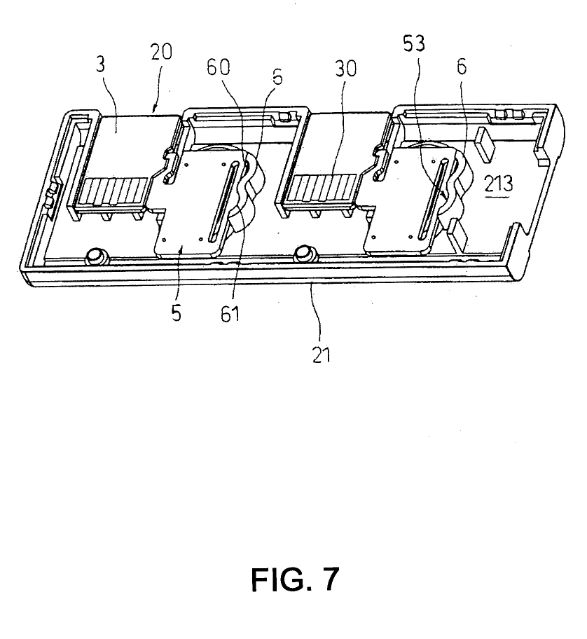

The lock member 6 is bent member and has one end fixedly connected to a member of the cover 21. The lock member 6 comprises a wavy section including two concave portions 60 and 61 each adapted to matingly engage the tab 53 of the inserted flash card 3. As shown in FIG. 7, the concave portion 61 matingly engages the tab 53 in an inserted position of the flash card 3. Also, terminals 30 of the inserted flash card 3 are electrically connected to the terminals 40 of the circuit board 4.

For ejecting the flash card 3, a user may first push the push button 54 from one end of the opening 212 to the other end thereof so as to move the tab 53 from the position of engaging the concave portion 61 to the position of engaging the concave portion 60. Thus, a portion of the flash card 3 projects from the slot opening 20. Next, the user may hold the projected portion of the flash card 3 to pull it out of the card reader by separating the flexibly lockingly engaged inclined portion 31 and dent 32 of the flash card 3 from the latch 52 of the sliding member 5. It is obvious that in a flash card insertion operation the user may insert the flash card 3 into the slot opening 20 until the flash card 3 is completed concealed by the card reader. At this position, the tab 53 engages the concave portion 61 and the inclined portion 31 and dent 32 of the flash card 3 flexibly lockingly engage the latch 52 of the sliding member 5.

The card ejection mechanism can effect the ejection of an inserted flash card by applying a minimum force to the flash card and the components of a card reader. Thus, both the flash card and the card reader are durable. Moreover, the inserted flash card is flexibly locked. Thus, a person does not need to worry that an inserted flash card may accidentally remove from a card reader while carrying.

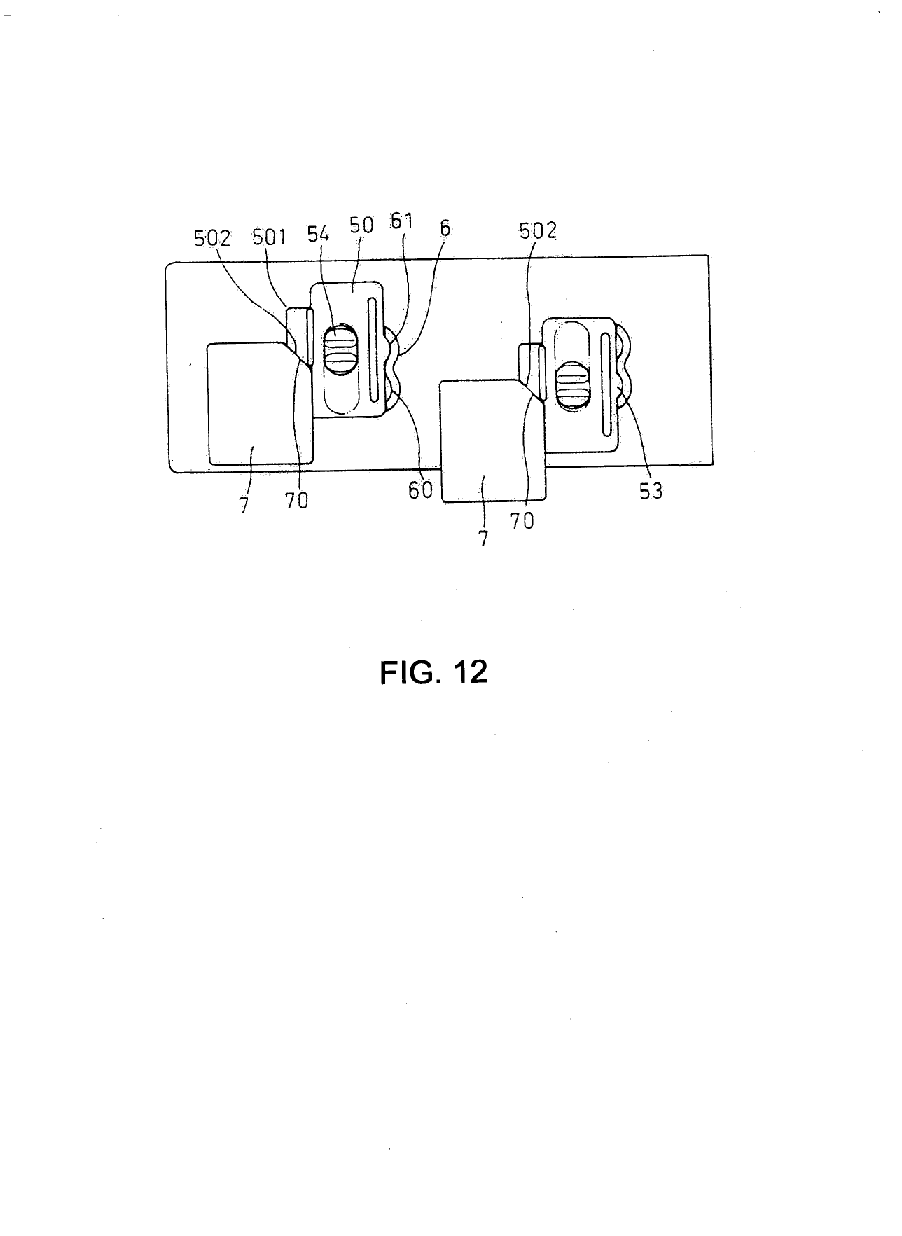

Referring to FIG. 12, a card reader in accordance with a third preferred embodiment of the invention. The third preferred embodiment substantially has same structure as the second preferred embodiment. The characteristics of the third preferred embodiment are detailed below. The extension 501, the arm 51, and the latch 52 of second embodiment are simplified as a trapezoidal extension 501 at the other side and a slope 521 formed on a side of the extension 501. The slope 521 is adapted to correspondingly engage an inclined portion 70 at one corner of a rectangular flash card 7. The sliding member 5 of this embodiment has simplified components.

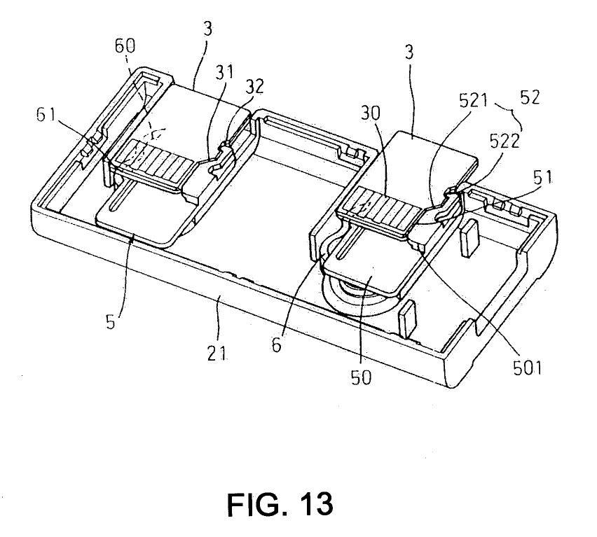

Referring to FIG. 13, a card reader in accordance with a fourth preferred embodiment of the invention. The fourth preferred embodiment substantially has same structure as the second preferred embodiment. The characteristics of the fourth preferred embodiment are detailed below. A rectangular body 50 of the sliding member 5 and the lock member 6 are disposed below the inserted flash card 3. Also, the extension 501, the arm 51, and the latch 52 of fourth embodiment are extended upward from one side of the body 50 prior to extending toward the inserted flash card 3. That is, they are overlain. This can greatly decrease size of the card reader. Thus, the card reader can be more compact. Note that in each of the second, third, and fourth embodiments the number of concave portions can be not equal to 2 in other embodiments depending on the length of the flash card.

While the invention herein disclosed has been described by means of specific embodiments, numerous modifications and variations could be made thereto by those skilled in the art without departing from the scope and spirit of the invention set forth in the claims.

What is claimed is:

1. A flash card reader comprising:
a housing having an internal space for receiving two flash cards; and
a circuit board disposed in the housing and including a plurality of electrical terminals at top and bottom surfaces thereof respectively, the electrical terminals of either surface being adapted to electrically connect electrical terminals of the inserted flash card,
wherein the housing comprises two slot openings each disposed at either side, and a space inside each slot opening, the space being slightly larger than a portion of the flash card inserted into the slot opening.

2. The flash card reader of claim 1, wherein the housing further comprises an internal wall for defining the space.

3. The flash card reader of claim 1, wherein the circuit board further comprises a connector projected from one end, the connector being adapted to insert into a port of an electronic device for data reading.

4. The flash card reader of claim 3, wherein the connector is a USB connector.

5. The flash card reader of claim 1, wherein the housing consists of a cover and a base assembled together with the circuit board disposed therebetween so as to divide the internal space of the housing into two compartments each adapted to receive the inserted flash card.

6. A flash card reader comprising:
a housing including two slot openings each disposed at either side, and a space inside each slot opening, the space being slightly larger than a portion of a flash card inserted into the slot opening;
a circuit board disposed in the housing and including a plurality of electrical terminals at one end, the electrical terminals being adapted to electrically connect electrical terminals of the inserted flash card; and
two sliding members disposed in the housing and each including an extended latch section,
wherein the latch section of the sliding member is adapted to lockingly engage a corresponding portion of the flash card inserted through the slot opening, the electrical terminals of the circuit board are adapted to electrically connect electrical terminals of the inserted flash card, and the latch section of the sliding member is adapted to disengage the corresponding portion of the inserted flash card for ejecting the flash card from the slot opening by operating the sliding member.

7. The flash card reader of claim 6, wherein the housing consists of a cover and a base assembled together.

8. The flash card reader of claim 7, wherein the cover comprises two oval openings formed thereon, and wherein the sliding member further comprises a top push button projected from the opening.

9. The flash card reader of claim 6, wherein the latch section comprises an extension at the other side, an arm oriented toward one side of the housing, and a latch including a slope, and an end protrusion, and wherein the flash card comprises a dent at one side, the dent being adapted to matingly engage the protrusion in response to inserting the flash card into the slot opening.

10. The flash card reader of claim 9, wherein the extension and the arm are shaped as an L such that the arm is adapted to flexibly bend toward a gap between the L and the sliding member while inserting the flash card into the slot opening or ejecting the flash card from the slot opening.

11. The flash card reader of claim 9, wherein the flash card further comprises an inclined portion at one side, and wherein the latch section further comprises a slope to be correspondingly engaged the inclined portion.

12. The flash card reader of claim 6, further comprising two bent lock members each having one end fixedly connected to the housing, each of the lock members being adapted to lock the sliding member.

13. The flash card reader of claim 12, wherein the lock member comprises a wavy section including two concave portions.

14. The flash card reader of claim 13, wherein the sliding member further comprises a tab at one side, the tab being adapted to matingly engage one of the concave portions.

15. The flash card reader of claim 6, wherein the sliding member further comprises a rectangular body, the body being disposed below the inserted flash card by a distance substantially equal to a height of the latch section.
